(19) United States
(12) Patent Application Publication
(10) Pub. No.: US 2020/0090076 A1
(43) Pub. Date: Mar. 19, 2020

(54) NON-TRANSITORY COMPUTER-READABLE RECORDING MEDIUM, PREDICTION METHOD, AND LEARNING DEVICE

(71) Applicant: FUJITSU LIMITED, Kawasaki-shi (JP)

(72) Inventors: Takashi KATOH, Kawasaki (JP); Hiroaki Iwashita, Tama (JP); Kotaro Ohori, Sumida (JP); Tatsuya Asai, Kawasaki (JP); Hikaru Yokono, Yokohama (JP)

(73) Assignee: FUJITSU LIMITED, Kawasaki-shi (JP)

(21) Appl. No.: 16/555,395

(22) Filed: Aug. 29, 2019

(30) Foreign Application Priority Data
Sep. 18, 2018 (JP) 2018-174292

(51) Int. Cl. G06N 20/00; G06N 5/00; G06N 5/04

(52) U.S. Cl. CPC G06N 20/00; G06N 5/04; G06N 5/003

(57) ABSTRACT

A learning device creates a plurality of decision trees, using pieces of training data respectively including an explanatory variable and an objective variable, which are configured by a combination of the explanatory variables and respectively estimate the objective variable based on true or false of the explanatory variables. The learning device creates a linear model that is equivalent to the plurality of decision trees, and lists all terms configured by a combination of the explanatory variables without omission. The learning device outputs a prediction result by using the linear model from input data.

### CROSS-REFERENCE TO RELATED APPLICATION

This application is based upon and claims the benefit of priority of the prior Japanese Patent Application No. 2018-174292, filed on Sep. 18, 2018, the entire contents of which are incorporated herein by reference.

### FIELD

The embodiments discussed herein are related to a non-transitory computer-readable recording medium, a prediction method, and a learning device.

### BACKGROUND

In machine learning, when discretizable data is to be handled, a learning model based on a decision tree is used in terms of readability and interpretability. When a single decision tree is used, a learning model different from an actual phenomenon is created due to lack of learning data and inaccuracy thereof, a parameter, or the like at the time of building the learning model, and a possibility that the accuracy at the time of application becomes extremely low cannot be excluded.

In recent years, a random forest in which data and characteristics to be used for learning are changed at random to create a plurality of decision trees and decision making is performed based on the principle of majority rule. In the random forest, even if a tree that extremely decreases the accuracy at the time of application is included, a certain degree of accuracy can be ensured as a whole.

In application of the machine learning, a stable learning model in which there are some grounds for a result is needed in some cases, for example, when it is desired to examine whether the result is reasonable or whether there is another possibility, or when it is desired to compare the result with that of a learning model in the past.

However, since the random forest includes randomness in creation of a learning model, a decision tree to be created may be biased. Further, when the learning data is few or inaccurate, it is difficult to know how much influence the randomness to be used in creation of the learning model by the random forest has on the output accuracy of the learning model. Therefore, an evidence that no bias has occurred cannot be provided, and thus the reliability of the prediction result by the machine learning is not always high. Further, to reduce the influence of randomness, it can be considered to increase the number of decision trees created at random. However, learning hours and a prediction time by a learned learning model become long, which is not realistic.

### SUMMARY

According to an aspect of an embodiment, a non-transitory computer-readable recording medium stores therein a program that causes a computer to execute a process. The process includes creating a plurality of decision trees, using pieces of training data respectively including an explanatory variable and an objective variable, which are configured by a combination of the explanatory variables and respectively estimate the objective variable based on true or false of the explanatory variables; creating a linear model that is equivalent to the plurality of decision trees and lists all terms configured by a combination of the explanatory variables without omission; and outputting a prediction result by using the linear model from input data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of a learning device according to a first embodiment;

FIG. 2 is a functional block diagram illustrating a functional configuration of the learning device according to the first embodiment;

FIG. 3 is a diagram illustrating an example of training data stored in training data DB;

FIG. 4 is an explanatory diagram of conversion from decision trees to a linear model;

FIG. 5 is an explanatory diagram of conversion from a forest model to a linear model and a calculation example of coefficients;

FIG. 6 is a flowchart illustrating a flow of learning processing;

FIG. 7 is an explanatory diagram of a learning device according to a second embodiment;

FIG. 8 is a diagram illustrating an example of a simple decision tree;

FIG. 9 is an explanatory diagram of a specific example using a simple decision tree in a simple forest model;

FIG. 10 is an explanatory diagram of a specific example of creation of a linear model corresponding to a cube;

FIG. 11 is an explanatory diagram of a specific example of a linear model according to the second embodiment;

FIG. 12 is a flowchart illustrating a flow of learning processing according to the second embodiment;

FIG. 13 is an explanatory diagram of a comparison result with a general technique; and

FIG. 14 is an explanatory diagram of a hardware configuration example.

### DESCRIPTION OF EMBODIMENTS

Preferred embodiments will be explained with reference to accompanying drawings. The present invention is not limited to the embodiments. Further, the respective embodiments can be combined with each other appropriately in a range without causing any contradiction.

### [a] First Embodiment

Overall Configuration

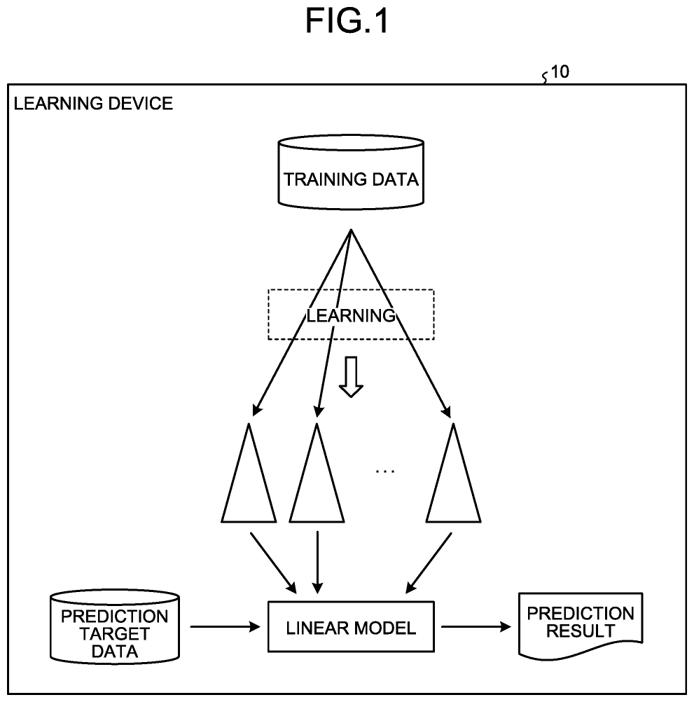

FIG. 1 is an explanatory diagram of a learning device 10 according to a first embodiment. The learning device 10 illustrated in FIG. 1 is an example of a computer device that creates a learning model by using training data given with a correct answer label to perform supervised learning and performs prediction (estimation) of data to be predicted by using the learned learning model. An example of realizing learning and prediction by the same device is described here. However, the present invention is not limited thereto, and learning and prediction can be realized by different devices.

In a general random forest, since model creation includes randomness, a decision tree to be created may be biased. Therefore, it is not possible to exclude a possibility that the overall accuracy becomes extremely low due to the bias, thereby causing an event in which results may change each time. On the other hand, if the number of decision trees created at random is increased, the possibility of bias can be reduced; however, time is needed for learning and application thereof. That is, the decrease of accuracy and high-speed processing time are in a trade-off relation with each other, and a learning model that can perform processing at a high speed with stable accuracy has been desired.

Therefore, the learning device 10 according to the first embodiment decisively creates all decision trees that can be created from pieces of training data, and creates a forest model that performs decision making based on the principle of majority rule to create a stable model. The learning device 10 then converts the forest model to a linear model that returns an equivalent result, to reduce a calculation time at the time of application.

Specifically, as illustrated in FIG. 1, the learning device 10 creates a plurality of decision trees, from pieces of training data respectively including an explanatory variable and an objective variable, which are configured by a combination of the explanatory variables and respectively estimate the objective variables based on true or false of the explanatory variables. Subsequently, the learning device 10 creates a linear model that is equivalent to the decision trees and that lists all terms formed by the combination of explanatory variables without omission.

Specifically, the learning device 10 resolves the respective decision trees included in the forest model into paths to build a linear model in which the presence of a path is set as a variable, and decides coefficients of the respective variables in the linear model based on the number of decision trees including the path, which are included in the forest model. Thereafter, the learning device 10 inputs data to be predicted into the decided linear model and performs calculation based on the linear model to output a prediction result.

In this manner, the learning device 10 increases the number of decision trees to improve stability at the time of learning, and can perform prediction without using the decision trees at the time of prediction (application). Therefore, the learning device 10 can reduce the processing time for acquiring stable prediction.

Functional Configuration

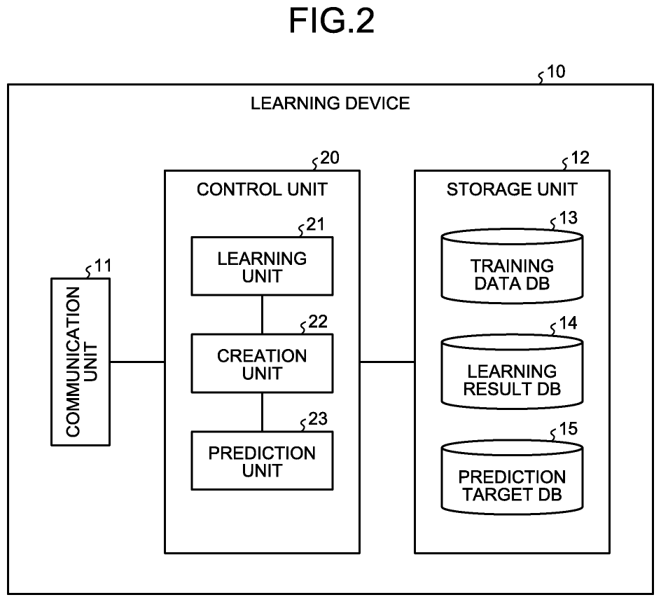

FIG. 2 is a functional block diagram illustrating a functional configuration of the learning device 10 according to the first embodiment. As illustrated in FIG. 2, the learning device 10 includes a communication unit 11, a storage unit 12, and a control unit 20. The processing units illustrated here are only examples, and the learning device 10 can also include a display unit or the like that displays various types of information.

The communication unit 11 is a processing unit that controls communication with other devices, and for example, is a communication interface. For example, the communication unit 11 receives training data to be learned, a learning start instruction, data to be predicted, a prediction start instruction, and the like from a manager's terminal or the like, and transmits a training result, a prediction result, and the like to the manager's terminal.

The storage unit 12 is an example of a storage device that stores therein data, a program executed by the control unit 20, and the like, and for example, is a memory or a hard disk. The storage unit 12 stores therein a training data DB 13, a learning result DB 14, a prediction target DB 15, and the like.

The training data DB 13 is a database that stores therein training data, which is data to be learned. Specifically, the training data DB 13 stores therein a plurality of pieces of training data respectively including an explanatory variable and an objective variable. The training data stored herein is stored and updated by a manager or the like.

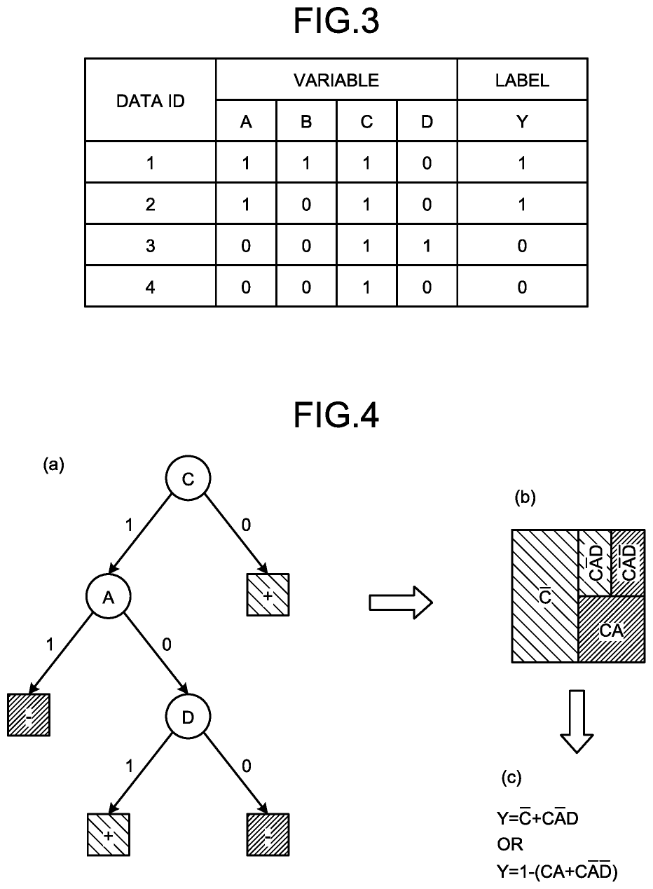

FIG. 3 is a diagram illustrating one example of training data stored in the training data DB 13. As illustrated in FIG. 3, the training data DB 13 stores therein training data in which “data ID, variable, label” are associated with each other. “Data ID” is an identifier identifying the training data. “Variable” is a variable describing the objective variable and corresponds to, for example, the explanatory variable. As the variable, data in various formats such as numerical data and category data can be used. “Label” is correct answer information provided to the training data and corresponds to, for example, the objective variable.

In the example of FIG. 3, a label “Y=1 (hereinafter, sometimes described as true, or positive, or plus (+))” is given to training data corresponding to an event being the objective variable. A label “Y=0 (hereinafter, sometimes described as false, or negative, or minus (−))” is given to training data not corresponding to the event being the objective variable. In data ID 1 in FIG. 3, “true” is given to the label “Y”, indicating that in the training data, variables A, B, and C are true, and a variable D is false.

As an example of a certain event, there is an example of determining “whether a risk of heatstroke is high”, in which “1” is set to the label Y of the training data indicating that the risk of heatstroke is high, and “0” is set to the label Y of the training data indicating others. In this case, as the explanatory variables such as the variable A, “whether the temperature is 30° C. or higher” can be presented, in which, when the temperature corresponds to 30° C. or higher, the variable A is determined as “1”, and when the temperature does not correspond to 30° C. or higher, the variable A is determined as “0”.

The learning result DB 14 is a database that stores a learning result by the control unit 20 described later. Specifically, the learning result DB 14 stores a linear model that is a learned learning model and is to be used for prediction.

The prediction target DB 15 is a database that stores data to be predicted. Specifically, the prediction target DB 15 stores data to be predicted that includes a plurality of explanatory variables and is data to be input to the linear model, which is a learned learning model.

The control unit 20 is a processing unit that controls the entire learning device 10, and is, for example, a processor. The control unit 20 includes a learning unit 21, a creation unit 22, and a prediction unit 23. The learning unit 21, the creation unit 22, and the prediction unit 23. The learning unit 21, the creation unit 22, and the prediction unit 23 are examples of an electronic circuit provided in the processor, or a process performed by the processor.

The learning unit 21 is a processing unit that creates a forest model including a plurality of decision trees based on training data. Specifically, the learning unit 21 reads respective pieces of training data stored in the training data DB 13, and decisively creates all the decision trees that can be created from the pieces of training data. The learning unit 21 creates a forest model that determines an output result of each of the created decision trees based on the principle of majority rule, and outputs the forest model to the creation unit 22.

For example, the learning unit 21 creates a plurality of decision trees, for each of the pieces of training data, which are configured by a combination of explanatory variables and presume (estimate) an objective variable by true or false of the explanatory variable, respectively. The learning unit 21 can create a decision tree by dividing data expressed by a set of a variable and a value thereof into some subsets, for each of the pieces of training data. As a method of creating a decision tree, various known methods can be employed.

The creation unit 22 is a processing unit that crates a linear model by using the plurality of decision trees created by the learning unit 21. Specifically, the creation unit 22 creates a linear model that is equivalent to the plurality of decision trees and lists all the terms formed by the combination of explanatory variables without omission. The creation unit 22 stores the linear model in the learning result DB 14 as a learned learning model.

For example, the creation unit 22 resolves the respective decision trees included in the forest model into paths to build a linear model (a partial linear model) in which the presence of a path is set as a variable, and decides coefficients of respective variables in the linear model based on the number of decision trees including the path, which are included in the forest model.

Conversion from the decision trees to a linear model is specifically explained here. FIG. 4 is an explanatory diagram of conversion from the decision trees to a linear model. A decision tree illustrated in FIG. 4 is a decision tree that performs determination in such a manner that data corresponds to an objective variable if not corresponding to the variable C, that data does not correspond to an objective variable if corresponding to the variable C and the variable A, that data does not correspond to an objective variable if corresponding to the variable C but not corresponding to the variable A and the variable D, and that data corresponds to an objective variable if corresponding to the variable C and the variable D but not corresponding to the variable A (see FIG. 4(a)).

For such a decision tree, the creation unit 22 creates a cube that is a product term of literals of an objective variable (see FIG. 4(b)), which corresponds to paths of a decision tree. The cube is, for example, a product term of explanatory variables, and is a product term of respective positive (true) explanatory variables, a product term of respective negative (false) explanatory variables, and a product term of respective positive explanatory variables and respective negative explanatory variables.

This point is specifically explained with reference to FIG. 4. For example, in FIG. 4, it is illustrated that a case not corresponding to the variable C and a case corresponding to the variable C, not corresponding to the variable A, and corresponding to the variable D have the same determination (true). Further, it is illustrated that a case corresponding to the variable C and the variable A and a case corresponding to the variable C and not corresponding to the variable A and the variable D have the same determination (false). While a matter not corresponding to the variable C (in other words, the variable C is false (negative)) is described by an “overline of C” in the drawings of the present embodiment (for example, FIG. 4), and is described by “C⁻” or “C bar” in the specification, they all indicate the same thing.

The creation unit 22 uses “the sum of cubes corresponding to a path with a leaf being true (+) or “1−(the sum of cubes corresponding to a path with a leaf being false (−))” to create a linear model equivalent to the decision tree (see FIG. 4(c)). In the present embodiment, this point is described by using “the sum of cubes corresponding to a path with a leaf being ‘true (+)’”.

Here, a product of literals appearing in a path from a root to a leaf of a decision tree is referred to as a product term (cube) representing the leaf. A formula in which the sum of cubes representing all the positive leaves of a decision tree or the sum of cubes representing all the negative leaves of the decision tree is subtracted from 1 represents a formula of a linear model equivalent to the decision tree. When a forest model formed by one or more decision trees is provided, all the decision trees included in the forest model are converted to a formula of a linear model by any method described above. These formulas are added, and the total is then divided by the number of decision trees included in the forest model, which represents a formula of a linear model equivalent to the forest model.

In the example of FIG. 4, the creation unit 22 creates a linear model “Y=C⁻+CA⁻D” by the sum of a path “C⁻” not corresponding to the variable C, which is a path with “the leaf being true”, and a path “CA⁻D” corresponding to the variable C, not corresponding to the variable A, and corresponding to the variable D. Further, the creation unit 22 uses the sum of a path “CA” corresponding to the variable C and the variable A, which is a path with “the leaf being false”, and a path “CA⁻D⁻” corresponding to the variable C and not corresponding to the variable A and the variable D, to create a linear model “Y=1−(CA+CA⁻D)”. In this manner, the creation unit 22 creates linear models corresponding to the respective decision trees.

Next, the creation unit 22 calculates the sum of partial linear models created from the respective decision trees based on the “sum of cubes corresponding to paths with the leaf being “true (+)”, and divides the calculated “sum of partial linear models” by the total number of decision trees, to convert the decision tree to a linear model returning a result equivalent to the forest model.

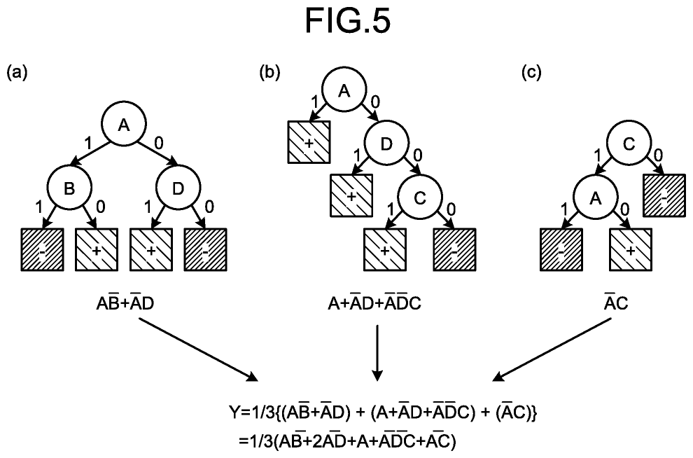

FIG. 5 is an explanatory diagram of conversion from a forest model to a linear model and a calculation example of coefficients. In FIG. 5, as an example, conversion from a forest model including three decision trees of a decision tree (a), a decision tree (b), and a decision tree (c) to a linear model is explained. As illustrated in FIG. 5, the creation unit 22 creates a partial linear model “Y=AB⁻+A⁻D” from the decision tree (a), creates a partial linear model “Y=A+A⁻D+A⁻D C” from the decision tree (b), and creates a partial linear model “Y=A⁻ C” from the decision tree (c).

Subsequently, the creation unit 22 calculates the sum of these partial linear models “(AB⁻+A⁻D)+(A+A⁻D+A⁻D⁻C)+(A⁻C)”=“AB⁻+2A⁻D+A+A⁻D⁻C+A⁻C”. Thereafter, the creation unit 22 creates “(AB⁻+2A⁻D+A+A⁻D⁻C+A⁻C)/3, which is obtained by dividing the sum of the partial linear models by the number of decision trees, which is 3. That is, the creation unit 22 creates “Y=(AB⁻+2A⁻D+A+A⁻D⁻C+A⁻C)/3” as a learned learning model (linear model).

Returning to FIG. 2, the prediction unit 23 is a processing unit that performs prediction of data to be predicted, which is stored in the prediction target DB 15, by using the linear model finally created by the creation unit 22. When explaining by the example described above, the prediction unit 23 acquires the data to be predicted from the prediction target DB 15, and acquires the linear model “Y=(AB⁻+2A⁻D+A+A⁻D⁻C+A⁻C)/3” from the learning result DB 14.

The prediction unit 23 assigns a value by assigning variables included in the data to be predicted to the linear model, thereby enabling to acquire a score from 0 to 1 inclusive. When the score exceeds 0.5, the objective variable in the data to be predicted can be estimated as 1, and in other cases, the objective variable in the data to be predicted can be estimated as 0.

For example, the prediction unit 23 assigns “AB⁻=1”, when a variable A and a variable B in the data to be predicted is “1, 0”. In this manner, the prediction unit 23 calculates a value at the time of inputting the data to be predicted to a linear model, and when the calculated value is equal to or larger than “0.5”, the prediction unit 23 predicts the data as “true:+” corresponding to a certain event, and when the calculated value is smaller than “0.5”, the prediction unit 23 predicts the data as “false:−” not corresponding to the certain event. The prediction unit 23 displays a prediction result on a display or transmits the prediction result to the manager's terminal.

Processing Flow

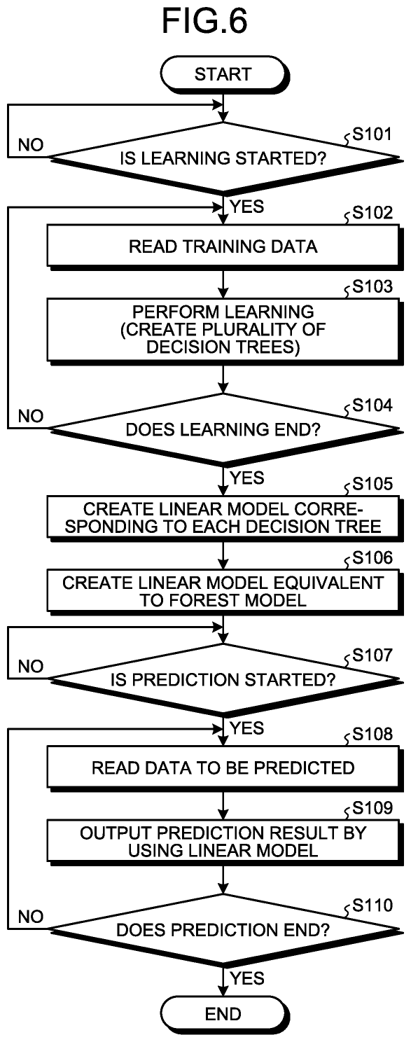

FIG. 6 is a flowchart illustrating a flow of learning processing. As illustrated in FIG. 6, when learning start is instructed from a manager or the like (YES at S101), the learning unit 21 reads respective pieces of training data from the training data DB 13 (S102), and performs learning to create a plurality of decision trees (S103). The learning unit 21 repeats steps S102 and thereafter until learning ends (NO at S104). A timing to end the learning can be arbitrarily set, for example, when learning is performed by using a predetermined number of pieces of training data.

When the learning ends (YES at S104), the creation unit 22 creates a linear model (a partial linear model) corresponding to each decision tree included in a created forest model (S105). Subsequently, the creation unit 22 creates a linear model equivalent to the forest model by using the partial linear models corresponding to the respective decision trees and the number of decision trees included in the forest model (S106).

Thereafter, when prediction start is instructed (YES at S107), the prediction unit 23 reads data to be predicted from the prediction target DB 15 (S108), and inputs the read data to be predicted to the linear model created at S106 to acquire a prediction result (S109). When there is remaining data to be predicted (NO at S110), the prediction unit 23 repeats steps at S108 and thereafter. When prediction is to be ended (YES at S110), the prediction unit 23 ends the processing.

In FIG. 6, an example in which learning and prediction are performed in a series of flow has been described; however, the present invention is not limited thereto, and learning and prediction can be performed in a separate flow. Further, the learning processing is repeatedly performed every time the training data is updated, and the linear model can be updated as needed.

### Effects

As described above, the learning device 10 can create a partial linear model corresponding to each decision tree that can be created from training data, and can create a linear model corresponding to a forest model by using the sum of respective partial linear models. Therefore, the learning device 10 can build a learning model that acquires stable prediction. Further, since the learning device 10 can perform prediction with respect to the data to be predicted by one linear model, without performing determination by a decision tree and determination by the principle of majority rule, the processing time can be reduced.

Further, since the creation unit 22 can suppress bias due to a decision tree by decisively creating all the decision trees that can be created from pieces of training data, the learning device 10 can suppress accuracy deterioration due to the bias. Further, since the learning device 10 creates a linear model of a decision tree corresponding to each piece of training data, the learning device 10 can indicate that there is no bias in the decision tree. Further, since the learning device 10 can suppress bias, the learning device 10 can acquire the same result at all times from the same data, and even if the number of decision trees increases, the learning device 10 can perform learning and application at a high speed. That is, the learning device 10 can overcome the defect of the random forest.

### [b] Second Embodiment

In the first embodiment, there has been described an example in which a linear model is created after a forest model including a plurality of decision trees is once created. However, the method of creating a linear model is not limited thereto. For example, when the size of the forest model is sufficiently large as compared with the number of cubes, it may be easier to count the number of decision trees including respective cubes with respective to the respective cubes than converting a decision tree one by one and totalizing the conversion results. Therefore, in the second embodiment, when it is assumed that a forest model has been built, the number of decision trees including the path thereof is counted, and a coefficient of a linear model is created without actually building the forest model, thereby reducing a calculation time at the time of learning.

Description of Learning Device

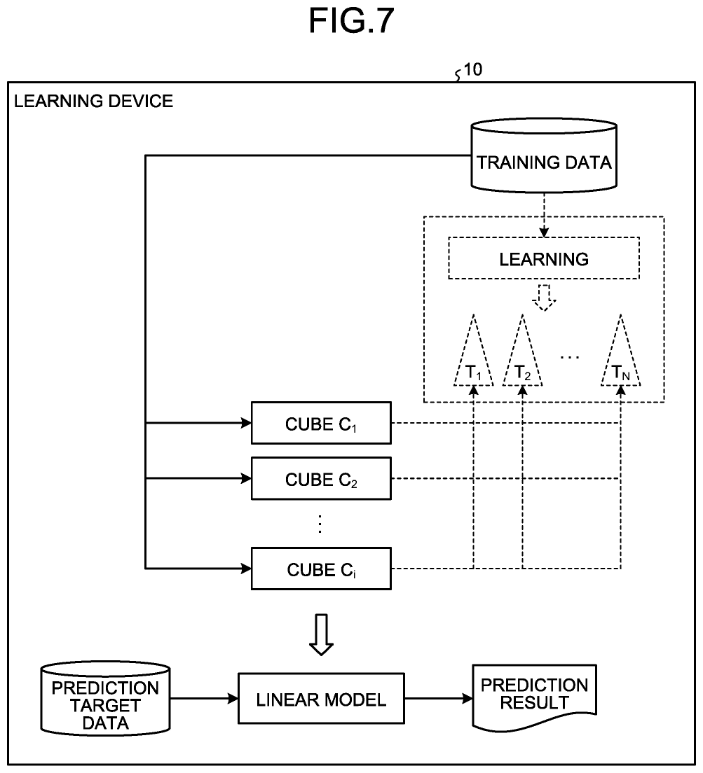

FIG. 7 is an explanatory diagram of the learning device 10 according to the second embodiment. As illustrated in FIG. 7, the learning device 10 according to the second embodiment creates respective cubes using a product of literals included in the training data without creating a forest model from the training data and the number of decision trees included in the respective cubes is counted.

Specifically, the learning device 10 creates a cube C₁ to a cube Cᵢ (i is a natural number) from the training data. The learning device 10 then studies a decision tree T₁ to a decision tree Tₙ (n is a natural number) including a cube and counts the number thereof with respect to each cube. In this manner, the learning device 10 specifies the number of respective cubes that can be created from the pieces of training data and the number of decision trees that can be considered to include a cube, and creates a linear model by use thereof. For example, when it is assumed that the number of trees including a cube C in a forest model F is “#_{F}(C)”, a linear model Y can be calculated as illustrated in Expression (1).

Y=E #_{F}(Ci)/N (1)

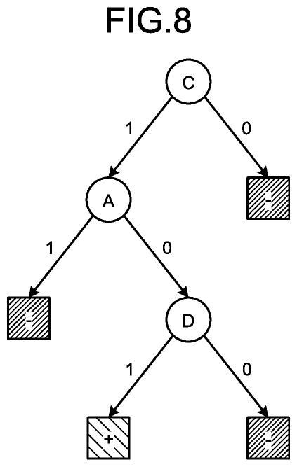

A simple decision tree is described here as an example. FIG. 8 is a diagram illustrating an example of a simple decision tree. As illustrated in FIG. 8, a simple decision tree has one leaf of true (+) (or false (−)), and can be converted to a linear model including one cube. Simple decision trees are listed with respect to each subset of n pieces of data. Targets to be listed are all decision trees that can have accuracy higher than a chance rate (for example, 0.5).

In this case, in an example of a subset of n pieces of data, assuming the number of variables as m, a forest model including about 2^{n+m} decision trees can be created with respect to one subset. For example, in a case of n=200 and m=20, a forest model including about 2²²⁰ decision trees can be acquired. Therefore, according to a method based on the principle of majority rule, a very large amount of time is needed, and thus the method is not realistic. In this manner, when the number of decision trees included in the forest model is very large, the method described in the second embodiment is particularly useful.

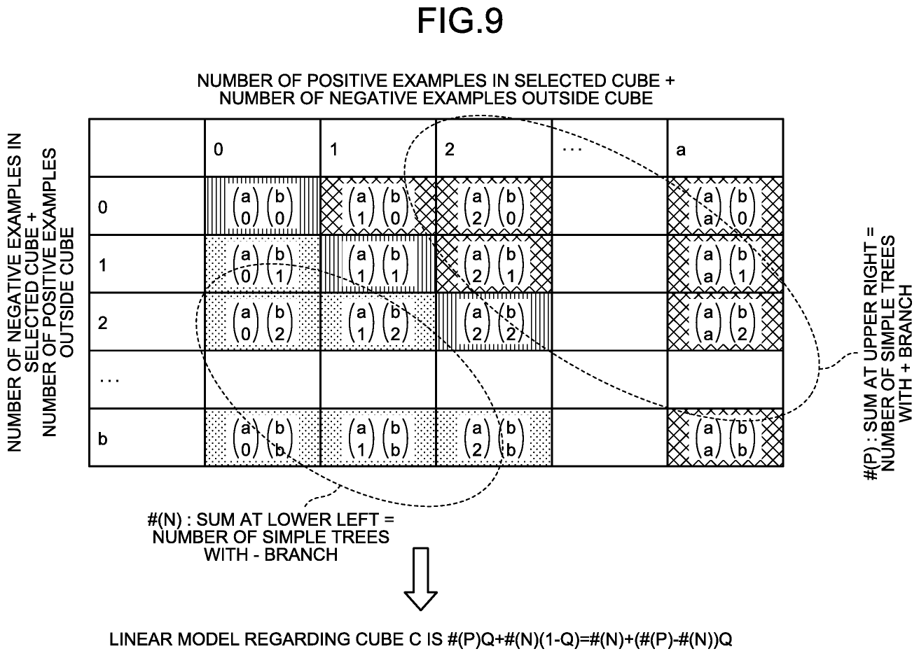

FIG. 9 is an explanatory diagram of a specific example using a simple decision tree in a simple forest model. The learning unit 21 of the learning device 10 obtains a “value a”, which is a total of positive example data satisfying a condition of a cube Q (residing in Q) and negative example data not satisfying the condition (residing outside the Q) from n pieces of training data, with respect to respective cubes for which a coefficient is respectively obtained. Subsequently, the number of data that is not included in the total described above which is a “value b (b=n−a)” (which is a total of the negative example data satisfying the condition of the cube Q and the positive example data not satisfying the condition) is obtained.

The learning unit 21 then obtains all the products of a combination number C(a, i) of selecting i pieces from a, and a combination number C(b, j) of selecting j pieces from b, with respect to an integer i from 0 to a inclusive and an integer j from 0 to b inclusive. When assuming that a rate of positive examples in the training data is “r=number of positive examples/n”, the learning unit 21 respectively obtains totals # (P) and # (N) regarding i and j satisfying i/(i+j)>r and i/(i+j)<r, of the number of combinations described above.

In this manner, the learning unit 21 obtains a coefficient “# (P)−# (N)” and a constant “# (N)” of the cube Q and the total number of trees “# (P)+# (N)” regarding the cube Q. By totalizing the constants and the coefficients and dividing the total thereof by the sum of the total number of decision trees with respect to all the cubes, the learning unit 21 can acquire a linear model that returns a result equivalent to that of a forest model using a simple decision tree.

When the case is described with reference to FIG. 9, the learning unit 21 counts the number of decision trees with a certain cube Q being true (+) and the number of decision trees with the certain cube Q being false (−). When it is assumed that the number of positive examples in the cube+the number of negative examples outside the cube is “a”, and the number of negative examples in the cube+the number of positive examples outside the cube is “b”, the learning unit 21 creates a table illustrated in FIG. 9. It is assumed that the chance rate is 0.5.

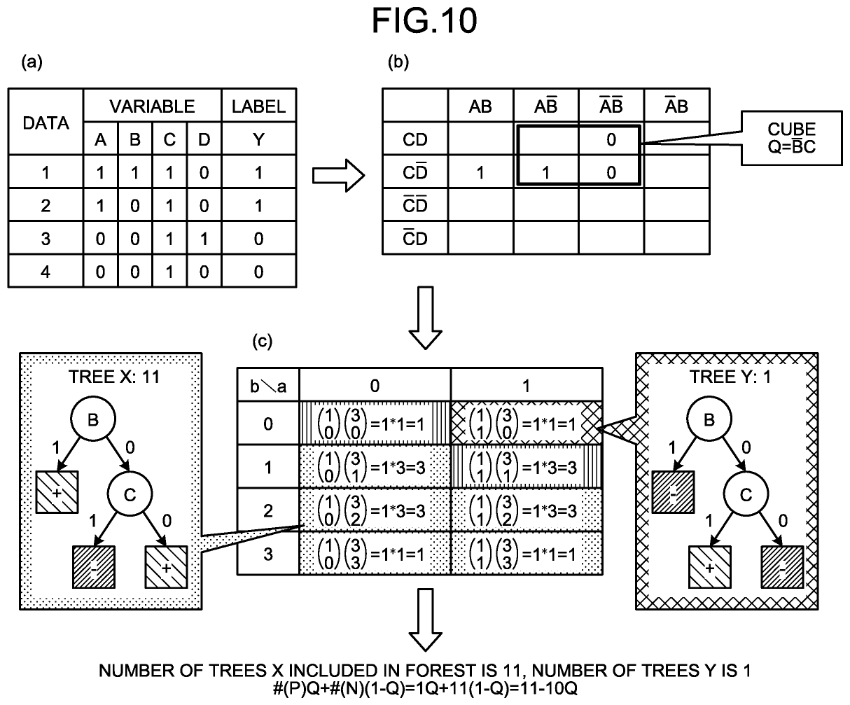

In a case of i/(i+j)=0.5=r from the table illustrated in FIG. 9, both conditions of i/(i+j)>r counted for # (P) and i/(i+j)<r counted for # (N) are not satisfied and no tree is present. Therefore, the condition of selecting the same number of a and b respectively (a diagonal line in FIG. 10) is excluded.

For example, the learning unit 21 counts the sum of the number of simple decision trees having a branch with “true (+)” as “# (P)”, which corresponds to upper right of the diagonal line in the table. Further, the learning unit 21 counts the sum of the number of simple decision trees having a branch with “false (−)” as “# (N)”, which corresponds to lower left of the diagonal line in the table. The creation unit 22 then calculates “# (P)Q+# (N) (1−Q)=# (N)+(# (P)−# (N))Q” as a linear model (a partial linear model) regarding the cube corresponding to FIG. 9.

A specific example is explained with reference to FIG. 10. FIG. 10 is an explanatory diagram of a specific example of creation of a linear model corresponding to a cube. It is assumed that the learning unit 21 creates a table illustrated in (b) in FIG. 10 from training data illustrated in (a) in FIG. 10 by a combination of variables A, B, C, and D in the training data. In this example, an example of counting the number of simple decision trees including a cube Q (Q=BC) in (b) in FIG. 10 is explained.

From (b) in FIG. 10, since the number of positive examples in the cube Q is 1 and the number of negative examples outside the cube is 0, the learning unit 21 counts the “value a” described above as “1”. Further, since the number of negative examples in the cube Q is 2 and the number of positive examples outside the cube is 1, the learning unit 21 counts the “value b” described above as “3”.

Subsequently, the learning unit 21 creates a table illustrated in (c) in FIG. 10 in which the “value a” is plotted on a horizontal axis and the “value b” is plotted on a vertical axis, and counts the number of decision trees including the cube C. Specifically, the learning unit 21 counts “1” being a combination of selecting one from the “value a”, as the number of correct answers given by a decision tree having a path to a leaf in the positive example. Further, the learning unit 21 counts “3” being a combination of selecting one from the “value b”, “3” being a combination of selecting two from the “value b”, and “1” being a combination of selecting three from the “value b”, as the number of correct answers given by a decision tree having a path to a leaf in the negative example. Similarly, the learning unit 21 counts “3” being a combination of selecting two from the “value b” and one from the “value a”, and “1” being a combination of selecting three from the “value b” and one from the “value a”, as the number of correct answers given by a decision tree having a path to a leaf in the negative example.

That is, the learning unit 21 calculates the total number of decision trees “# (P)” having the path to the leaf in the positive example as “1”, and the total number of decision trees “# (N)” having the path to the leaf in the negative example as “3+3+1+3+1=11”. As a result, the learning unit 21 can create “# (P)Q+# (N) (1−Q)=1Q+11(1−Q)=11−10Q” as a linear model corresponding to the cube Q.

Thereafter, the learning unit 21 performs creation of a linear model with respect to each cube included the table illustrated in (b) in FIG. 10 and counting of the number of decision trees including the cube. The creation unit 22 creates a linear model (learning model) equivalent to a forest model including a plurality of decision trees created decisively from the pieces of training data without omission by using the result obtained by the learning unit 21.

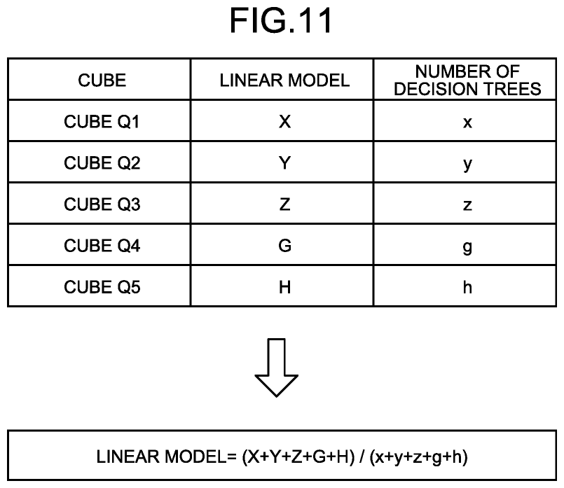

FIG. 11 is an explanatory diagram of a specific example of a linear model according to the second embodiment. As illustrated in FIG. 11, it is assumed that a “linear model X” and the number of decision trees “x” are created regarding a cube Q1, a “linear model Y” and the number of decision trees “y” are created regarding a cube Q2, a “linear model Z” and the number of decision trees “z” are created regarding a cube Q3, a “linear model G” and the number of decision trees “g” are created regarding a cube Q4, and a “linear model H” and the number of decision trees “h” are created regarding a cube Q5 by the learning unit 21.

In this case, the creation unit 22 creates “Y=sum of respective linear models (X+Y+Z+G+H)/sum of total number of decision trees including the respective linear models (x+y+z+g+h)”, as a final linear model (learning model). As a result, the learning device 10 can create a linear model, which is a learned learning model, without actually building a forest model and can reduce the calculation time at the time of learning.

Processing Flow

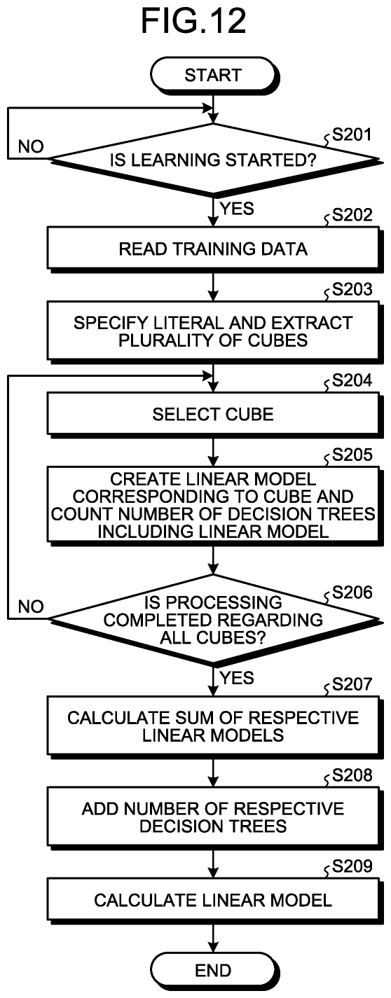

FIG. 12 is a flowchart illustrating a flow of learning processing according to the second embodiment. As illustrated in FIG. 12, when learning start is instructed (YES at S201), the learning device 10 reads training data from the training data DB 13 (S202).

Subsequently, the learning device 10 specifies a literal in the training data to extract a plurality of cubes (S203). The learning device 10 then selects one cube (S204), creates a linear model corresponding to the cube, and counts the number of decision trees including the linear model (S205).

When there is a non-processed cube (NO at S206), processes at S204 and thereafter are repeated. On the other hand, when processing is completed regarding all the cubes (YES at S206), the learning device 10 calculates the sum of linear models corresponding to the respective cubes (S207), and adds the number of decision trees including the respective cubes (S208).

The learning device 10 then creates a linear model equivalent to a forest model by dividing the sum of linear models by the number of decision trees (S209). Since the prediction processing is the same as that of the first embodiment, detailed descriptions thereof are omitted.

### Effects

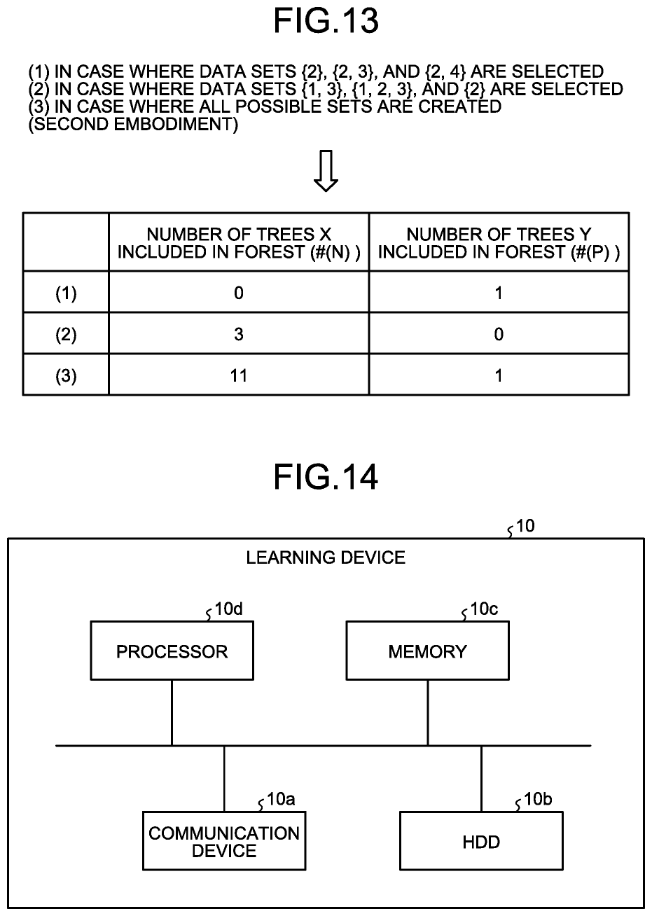

As described above, the learning device 10 can calculate a forest model including about 2^{n+m} trees based on the principle of majority rule by counting about 2^{m}n² times and can increase the processing speed. FIG. 13 is an explanatory diagram of a comparison result with a general technique. In FIG. 13, in the training data illustrated in (a) in FIG. 10, a comparison result is illustrated among a case (1) where respective data sets of “(data 2), (data 2, 3, 4) and (data 2, 4)” are selected, a case (2) where respective data sets of “(data 1, 3), (data 1, 2, 3), and (data 2)” are selected, and a case (3) where the method according to the second embodiment is used.

In the method of (1), the number of # (P) becomes 0, and in the method of (2), the number of # (N) becomes 0, and thus it cannot be suppressed that an extreme result is obtained by sampling. In contrast, according to the method of the second embodiment, all the decision trees can be studied without omission. Therefore, # (P) and # (N) can be also studied, thereby enabling to suppress creation of a learning model biased to an extreme result.

### [c] Third Embodiment

While embodiments of the present invention have been described above, the present invention can be implemented in various different modes other than the embodiments described above.

Limitation of Path

For example, a path to be used for a linear model can be limited. Specifically, the path is limited to the one having the number of literals of the explanatory variable equal to or smaller than a predetermined value. One literal corresponds to a fact that a value of a certain explanatory variable is 1 (positive: true) or 0 (negative: false). Therefore, a condition that the number of literals is equal to or smaller than a predetermined value limits the number of relevant explanatory variables to be equal to or smaller than a predetermined number, thereby enhancing generality of learning.

System

The information including the processing procedure, the control procedure, specific names, and various kinds of data and parameters illustrated in the above description or in the drawings can be optionally changed, unless otherwise specified.

The respective constituents of the illustrated apparatus are functionally conceptual, and the physically same configuration is not always needed. In other words, the specific mode of dispersion and integration of the device is not limited to the illustrated one, and all or a part thereof may be functionally or physically dispersed or integrated in an optional unit, according to the various kinds of load and the status of use. For example, leaning and prediction can be implemented by separate devices such as a learning device including the learning unit 21 and the creation unit 22, and a discrimination device including the prediction unit 23.

All or an optional part of the various processing functions performed by the respective device can be realized by a CPU or a program analyzed and executed by the CPU, or can be realized as hardware by the wired logic.

Hardware

FIG. 14 is an explanatory diagram of a hardware configuration example. As illustrated in FIG. 14, the learning device 10 includes a communication device 10a, an HDD (Hard Disk Drive) 10b, a memory 10c, and a processor 10d. The respective units illustrated in FIG. 14 are connected to each other by a bus or the like.

The communication device 10a is a network interface card or the like, and performs communication with other servers. The HDD 10b stores therein a program that causes the functions illustrated in FIG. 2 to operate and DBs.

The processor 10d reads a program for executing the same processing as that of the respective processing units illustrated in FIG. 2 from the HDD 10b or the like and develops the program in the memory 10c, thereby causing a process for performing the respective functions described with reference to FIG. 2 and the like to operate. That is, the process performs the same functions as those of the respective processing units provided in the learning device 10. Specifically, the processor 10d reads programs having the same functions as those of the learning unit 21, the creation unit 22, the prediction unit 23, and the like from the HDD 10b or the like. The processor 10d performs the process that performs the same processing as that of the learning unit 21, the creation unit 22, the prediction unit 23, and the like.

In this manner, the learning device 10 operates as an information processing device that performs a prediction method by reading and executing the program. Further, the learning device 10 can realize the same functions as those of the embodiments described above by reading the program from a recording medium by a media reader and executing the read program. Programs in other embodiments are not limited to being executed by the learning device 10. For example, the present invention can be applied to a case in which other computers or servers execute the program, or in which the computers or servers cooperate with each other to execute the program.

According to the embodiments, it is possible to reduce a processing time for acquiring stable prediction.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
creating a plurality of decision trees, using pieces of training data respectively including an explanatory variable and an objective variable, which are configured by a combination of the explanatory variables and respectively estimate the objective variable based on true or false of the explanatory variables;
creating a linear model that is equivalent to the plurality of decision trees and lists all terms configured by a combination of the explanatory variables without omission; and
outputting a prediction result by using the linear model from input data.

2. The non-transitory computer-readable recording medium according to claim 1, wherein the creating includes creating a plurality of partial linear models corresponding to each of the decision trees by using a sum of paths with a leaf being true or a sum of paths with a leaf being false, and creating a result acquired by dividing a sum of the partial linear models by a total number of the decision trees as the linear model equivalent to the plurality of decision trees.

3. The non-transitory computer-readable recording medium according to claim 1, wherein the outputting includes predicting that the prediction result corresponds to the objective variable when the prediction result is equal to or larger than a threshold, predicting that the prediction result does not correspond to the objective variable when the prediction result is smaller than the threshold.

4. A prediction method comprising:
creating a plurality of decision trees, using pieces of training data respectively including an explanatory variable and an objective variable, which are configured by a combination of the explanatory variables and respectively estimate the objective variable based on true or false of the explanatory variables, using a processor;
creating a linear model that is equivalent to the plurality of decision trees and lists all terms configured by a combination of the explanatory variables without omission, using the processor; and
outputting a prediction result by using the linear model from input data, using the processor.

5. A prediction method comprising:
specifying, from pieces of training data respectively including an explanatory variable and an objective variable, a combination of the explanatory variables, using a processor;
creating a linear model that is configured by a combination of the explanatory variables, is equivalent to a plurality of decision trees that respectively estimate the objective variable based on true or false of the explanatory variables, and lists all terms configured by a combination of the explanatory variables without omission, using the processor; and
outputting a prediction result by using the linear model from input data, using the processor.

6. A learning device comprising:
a memory; and
a processor coupled to the memory and the processor configured to:
create a plurality of decision trees, using pieces of training data respectively including an explanatory variable and an objective variable, which are configured by a combination of the explanatory variables and respectively estimate the objective variable based on true or false of the explanatory variables;
create a linear model that is equivalent to the plurality of decision trees and lists all terms configured by a combination of the explanatory variables without omission; and
output a prediction result by using the linear model from input data.
